(19) United States
(12) Patent Application Publication
(10) Pub. No.: US 2005/0165836 A1
(43) Pub. Date: Jul. 28, 2005

(54) Method for managing solid matter or building material

(76) Inventors: Takashi Suzuki, Tokyo (JP); Hitoshi Yamaguchi, Tokyo (JP)

Correspondence Address: Millen White Zelano & Branigan, 2200 Clarendon Boulevard, Suite 1400, Arlington, VA, 22201, US

(21) Appl. No.: 10/507,834

(22) PCT Filed: Mar. 25, 2002
(86) PCT No.: PCT/JP02/02859

(51) Int. Cl. G06F 17/00; G06F 7/00

(52) U.S. Cl. 707/104.1

(57) ABSTRACT

The present invention relates to an administration method for solid materials and, particularly, to an administration method for reusable building materials. In an administration server for administering solid materials affixed with specific serial numbers, the method comprises the steps of constructing a database storing the serial numbers and pieces of history information of the solid materials in one-to-one correspondence with the serial numbers for reusable solid materials, receiving information specifying a structure to be built by the solid materials from a user terminal accessible via a network, specifying all parts necessary to build the structure, and selecting the solid materials corresponding to the parts from the database.

### FIELD OF THE INVENTION

The present invention relates to an administration method for solid materials affixed with specific serial numbers, particularly building materials affixed with specific serial numbers.

### BACKGROUND OF THE INVENTION

General business investment plans such as physical distribution warehouses factories, restaurants, convenience stores, general merchandising stores, and food processing factories are built using many building materials. Building materials of such buildings include various kinds of materials such as steel frames to become frameworks, panels to form walls, various doors, various window sashes.

For example, in the case of relocating a certain restaurant from point A to another point B, it is necessary to first pull down the restaurant at point A and then to newly build a restaurant at point B. In such a case, when the restaurant at point A is pulled down, many building materials that are reusable in themselves are discarded, and new building materials are used for the restaurant to be built at point B.

Equipment in the restaurant such as kitchen cabinets, desks and chairs can be reused even if the restaurant is relocated, but various building materials of the restaurant once pulled down cannot be reused as a general rule.

This is because a plan before starting the construction of a restaurant, store or the like is not premised on dismantling and relocation and it has been a view widely held in the construction industry that economical effects of dismantling and relocation are questionable even if such a plan is made. The questionableness of the economical effects mentioned here includes higher construction costs than in usual cases and a considerable work load for such a plan. Generally, if dismantling and relocation are tried, it is considered necessary to affix serial numbers to dismantled members. However, such a system has not existed up to now.

As described above, in the case of dismantling a building, there are many building materials that can be reused within their service lives. A method for effectively reusing such building materials has not been established yet.

An object of the present invention is to provide an administration method for solid materials, particularly an administration method for reusable building materials.

### SUMMARY OF THE INVENTION

In order to accomplish the above object, the present invention is directed to an administration method for solid materials in an administration server for administering solid materials affixed with specific serial numbers, comprises the steps of constructing a database storing the serial numbers and pieces of history information of solid materials in one-to-one correspondence with the serial numbers for reusable solid materials, receiving information specifying a structure built by the solid materials from a user terminal accessible via a network, specifying all parts necessary to build the structure, and selecting solid materials corresponding to the parts from the database.

It is preferable to assume that a new solid material is used for each part which could not be selected from the database. Further, it is preferable to calculate prices of the reusable solid materials selected from the database and the new solid materials, and transmit information on the calculation result to the user terminal.

In order to accomplish the above object, the present invention is also directed to an administration method for solid materials in an administration server for administering solid materials affixed with specific serial numbers, the method comprises the steps of constructing a database storing the serial numbers and pieces of history information of solid materials in one-to-one correspondence with the serial numbers for reusable solid materials, receiving information specifying a structure built by the solid materials from a user terminal accessible via a network, specifying all solid materials obtained in the case of dismantling the structure, and sorting each of all the solid materials to be any one of a reused product, a reproduced product and a discarded product in accordance with the pieces of history information using the database.

It is preferable to calculate prices of the solid materials sorted to be the reused products and the reproduced products.

The history information is preferably information on the remaining life of each solid material or information on an owner of each reusable solid material.

Further, the solid materials are preferably building materials and the structures are preferably buildings.

In order to accomplish the above object, the present invention is further directed to an administration method for building materials, the method comprises the steps of affixing specific serial numbers to the building materials, and administering the building materials affixed with the specific serial numbers in accordance with the specific serial numbers and information on the remaining lives of the building materials. Such an administration using the specific serial numbers enables pieces of history information such as remaining lives to be administered for all the recyclable building materials. Therefore, the building materials can be used again in conformity with the Building Standards Act.

In order to accomplish the above object, the present invention is further directed to an administration method for building materials, the method comprises the steps of affixing specific serial numbers to the building materials, building a database storing the specific serial numbers, information on the building materials affixed with the specific serial numbers, and information on the remaining lives of the building materials affixed with the specific serial numbers, and selecting the building materials which can be used for a building from the database. Thus, the reusable building materials can be selected and provided using the database in the case of trying to relocate a building.

In order to accomplish the above object, the present invention is further directed to an administration method for building materials, the method comprises the steps of affixing specific serial numbers to the building materials, building a database storing the specific serial numbers, information on the building materials affixed with the specific serial numbers, and information on the remaining lives of the building materials affixed with the specific serial numbers; specifying all building materials necessary for a building to be newly built, and selecting the specified building materials from the database. Thus, the reusable building materials can be selected and provided using the database in the case of trying to build a new building.

In order to accomplish the above object, the present invention is further directed to an administration method for building materials, the method comprises the steps of constructing a database storing specific serial numbers, information on building materials affixed with the specific serial numbers, and information on the remaining lives of the building materials affixed with the specific serial numbers, specifying the building materials affixed with the specific serial numbers and usable to build a building, and distinguishing each specified building material into any one of a reproduced product, a reused product and a discarded product using the database. Thus, the building materials can be distinguished as reproduced products or reused products without discarding all the building materials forming the building to be dismantled.

The information on the building materials is preferably information on the prices of the building materials or information representing whether each building material is a reproduced product or a reused product.

### BRIEF DESCRIPTION OF THE DRAWINGS

FIG. 1 is a diagram showing an administration method for building materials and the construction of a system according to one embodiment of the invention,

FIG. 2 is a diagram showing a built state of a mobile building (MB),

FIG. 3 is a flow chart showing a procedure of requesting a MB to be newly built,

FIG. 4 is a flow chart showing a procedure of requesting a MB to be relocated,

FIG. 5 is a flow chart showing a procedure of requesting a MB to be dismantled,

FIG. 6 is a diagram showing one example of a model database (DB) 101,

FIG. 7 is a table showing one example of a building material DB 103,

FIG. 8 is a table showing one example of a charge DB 104, and

FIG. 9 is a table showing one example of a building DB 102.

### DESCRIPTION OF THE PREFERRED EMBODIMENT

Hereinafter, one embodiment of the present invention is described with reference to the accompanying drawings.

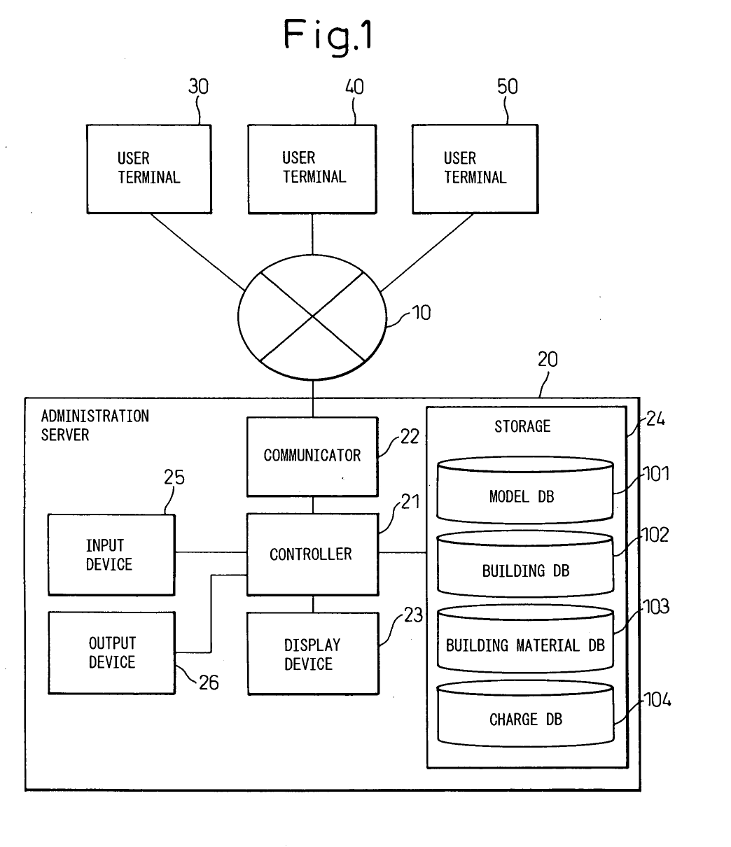

FIG. 1 is a schematic diagram showing the construction of a system implementing an administration method for building materials according to the present invention. Identified by 10 is a closed and open network such as a LAN, a WAN or Internet, by 20 an administration server connected with the network 10, by 30 to 50 user terminals connected with the network 10. It should be noted that the number of the user terminals is not restricted to the shown number.

The administration server 20 is constructed by a CPU or the like and includes a controller 21 having various information processing functions and other functions, a communicator 22 for transmitting and receiving various pieces of information, a display device 23 formed by a display or the like for displaying various pieces of information, a storage 24 formed by a memory or the like and capable of saving various pieces of information, an input device 25 formed by a key array, a keyboard, a mouse, a remote controller or the like and capable of inputting various pieces of information, and an output device 26 formed by a printer or the like and capable of printing out various pieces of information. In the storage 24 are saved a main program for executing various processings in the administration server 20, a model-type database (hereinafter, “model DB”) 101, a registered building database (hereinafter, “building DB”) 102, a building material database (hereinafter, “building material DB”) 103, and a charge database (hereinafter, “charge DB”) 104. The model DB 101, the building DB 102, the building material DB 103 and the charge DB 104 can be connected and separated if necessary. Other databases can be also saved in the storage 24.

Although it is not specified, each of the user terminals 30 to 50 is assumed to include a communicator for transmitting and receiving various pieces of information, a display device, an input device, a storage, a controller and the like.

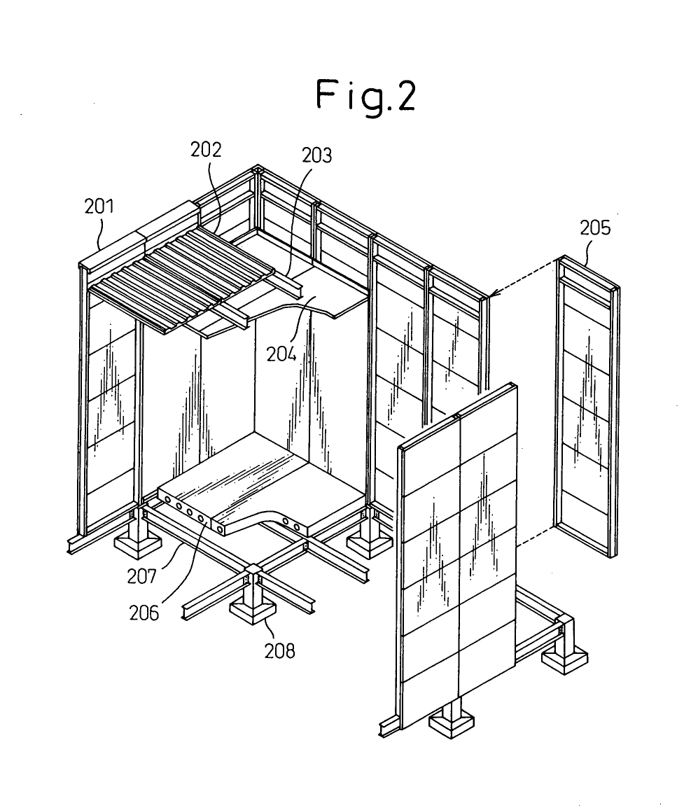

FIG. 2 shows an assembled state of a building (hereinafter, merely “MB (mobile building)”) using only building materials affixed with serial numbers. The MB is comprised of top beam units 201, roof units 202, beam units 203, ceiling units 204, wall units 205, floor units 206, foundation beam units 207, foundation units 208, window units, door units, various joining parts such as screws and bolts, and the like. In the MB, specific serial numbers are imprinted or printed on all the units and all the parts, even down to one screw, so that the units and parts can be clearly distinguished from each other. For example, in the MB shown in FIG. 2, a plurality of completely identically shaped wall units 205 are used. These wall units 205 have individual serial numbers imprinted thereon so as to be individually distinguishable.

In the MB, various units are fixed to each other by various jointing parts and a wet method of construction such as welding or adhesion is not basically used. Accordingly, the MB once assembled can be completely dismantled afterwards without destroying various units.

Further, the serial numbers imprinted or printed on the respective units and parts are unique even if the MBs to be built differ, and are numbers completely specific for solid materials. Accordingly, none of building materials administered by the administration server 20 to be described later, even down to a single screw, is affixed with the same serial number as another building material.

Next, the serial numbers to be imprinted or printed on the respective building materials are described. In this embodiment, each serial number is an alphanumeric character set comprised of four parts as below.

(Example) MBS-BA-21361-002

The first part (MBS) represents the classification of the building. For example, setting can be made such that MBP, MBS, MBC represent a physical distribution warehouse, a restaurant, a convenience store, respectively. Thus, the above example presents a building material used for a restaurant.

The second part (BA) represents an area used for this building material in the building and whether or not the building material is used for a section of the building to face a street. For example, the first letter can be set at A, B, C, and D (A corresponds to the largest area used for this building material, B corresponds to the second largest area, C corresponds to the third area, and D corresponds to the smallest area.). Also, the second letter can be set at A if the building material is to face the street and at B if it is not to face the street. Accordingly, the above example represents a building material whose area used for this building material is the second largest and which is to be used for a section of the building to face the street.

The third part (21361) represents the product name of the building material. Here, product classification numbers issued by the Management and Coordination Agency are used, and 21361 represents a metal blind.

The last part (002) represents a specific number. In other words, this part represents that this building materials is the second product handled by the administration server 20 of this embodiment out of products having the product classification number of 21361. It should be noted that the last part is not restricted to three digits.

The aforementioned serial number is only an example, and various other methods can be adopted to construct serial numbers. In the case that the building material has only a little place to imprint or print such as a screw or a bolt, imprinting or printing can be made smaller (for example, to such an extent that it is distinguishable using a specified optical device in spite of being undistinguishable by the eyes). Numbers and alphabets may be imprinted or printed as they are as above, or the serial numbers converted into bar codes may be imprinted or those saved in an IC chip or the like may be embedded in the building materials. In any case, various other methods can be adopted provided that the specific serial numbers can be distinguished and cannot be easily changed.

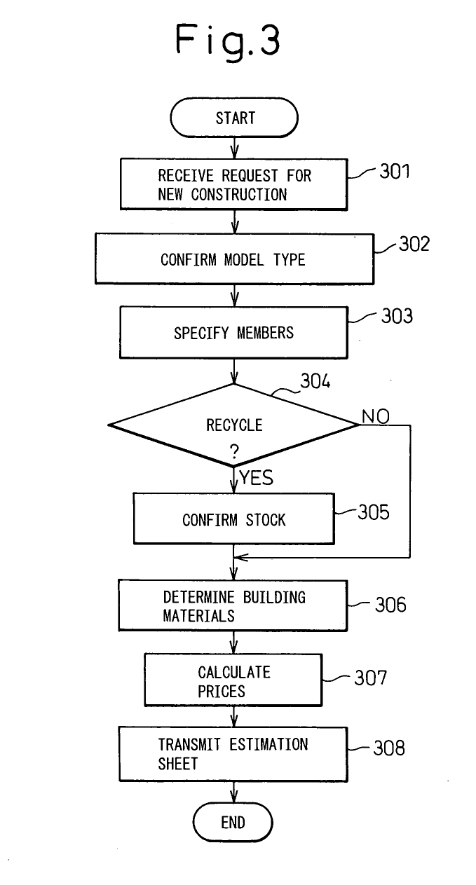

With reference to FIG. 3, a procedure of the administration method for building materials in the case of requesting a MB to be newly built is described. The procedure of FIG. 3 is implemented mainly by the controller 21 in accordance with the main program saved in the storage 24. It is assumed that a necessary user registration is done between the server 20 and the user terminal 30 and necessary data are saved in the various databases in advance before starting this procedure. Particularly, it is assumed that model patterns of several MBS conforming to the intention of a user are prepared in the aforementioned user registration and saved in the model DB 101.

First, the administration server 20 receives a required for new construction from the user terminal 30 of the user desiring the MB to be newly built (Step 301). The first request from the user terminal 30 includes information on the model type of the MB desired to be newly built and information on whether or not reusable building materials are to be used for the new construction.

Subsequently, the administration server 20 confirms the model type of the MB desired to be newly built based on the information from the user terminal 30 (Step 302). The outside drawings, plan views and the like of all the selectable model types may be transmitted from the administration server 20 to the user terminal 30 to enable the selection at the side of the user terminal 30 or a storage medium (CD-ROM or the like) saving information on the model types may be distributed to the user terminal in advance.

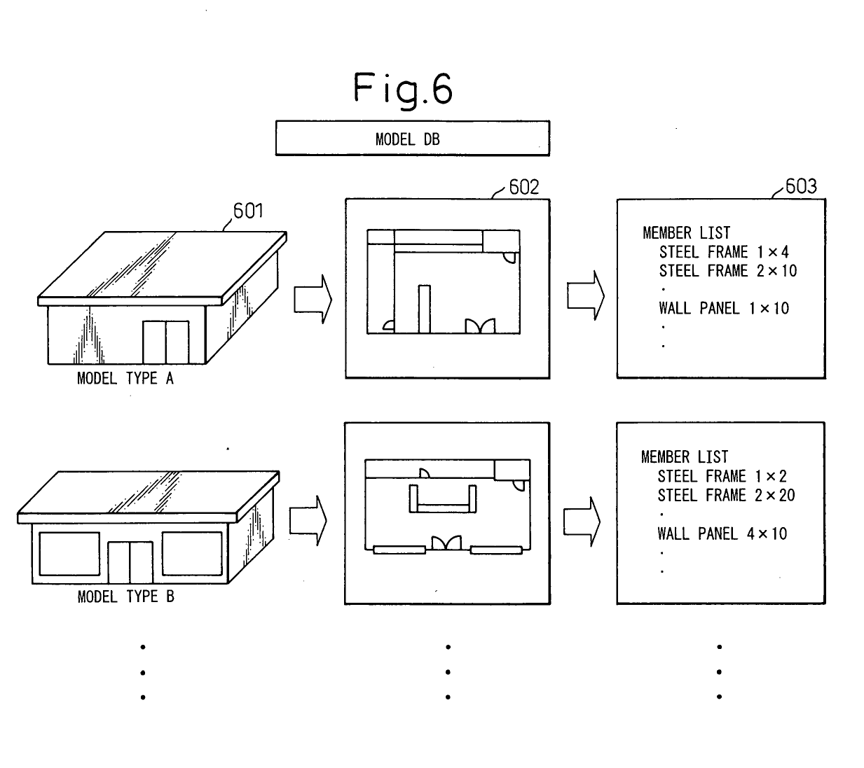

The administration server 20 then specifies all the members necessary for the MB desired to be newly built using the model DM 101 (Step 303). FIG. 6 shows one example of the model DB 101. The model DB 101 includes outer configuration image information 601, working drawings 602, and a member list 603 of all the members necessary for the construction, and the outer configuration image information, working drawings and the member lists of all the model types are saved in the model DB 101.

Subsequently, the administration server 20 judges whether or not the user terminal 30 desires the use of reusable building materials for the new construction (Step 304). If the user terminal 30 desires the use of the reusable building materials, Step 305 follows. The administration server 20 confirms whether or not the members specified in Step 303 are registered as stock in the building material DB 103 (Step S305).

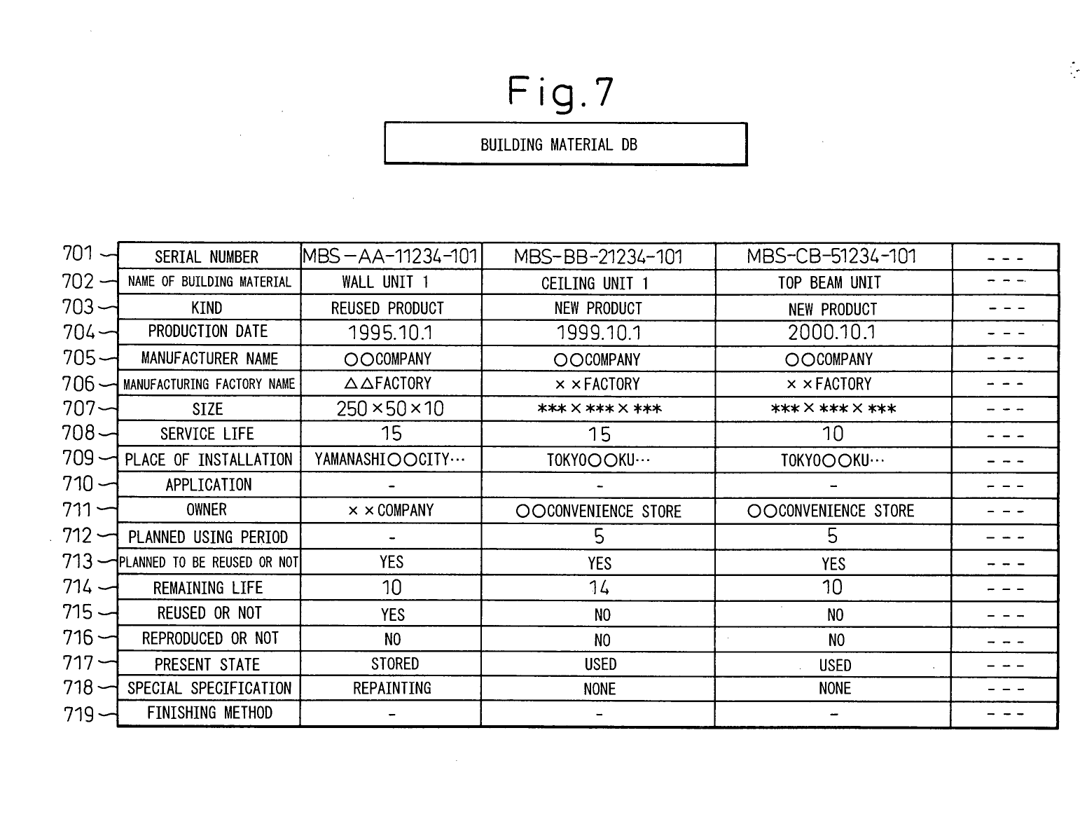

FIG. 7 shows one example of the building material DB 103. It is assumed that information on all the building materials stored or used at that point of time is registered in the building material DB 103. The building material DB 103 includes data items such as a serial number data 701, a building material name data 702, a kind data 703, a production date data 704, a manufacturer name data 705, a manufacturing factory name data 706, a size data 707, a service life data 708 at the time of production, a present installation place data 709, an application data 710, a present owner data 711, a planned using period data 712, a planned reuse data 713, a remaining service life data 714, a reuse data 715, a reproduction data 716, a present state data 717, a special specification data 718 and a finishing method data 719.

Here, the kind data 703 represents whether the building material affixed with a corresponding serial number is a new material, a reused material or a reproduced material. The reused material is a used material that is used as it is (without any repair, repainting or the like as a general rule), whereas the reproduced material is a used material that is used again after being repaired, repainted or the like. The application data 710 represents applications of the material if the same building material can be used in different applications. For example, if the same type of bolts and nuts are used to join the beams and to join the wall units, the application data 710 represents the application of the building material for the “beam” or the “wall unit”.

The remaining service life data 714 represents how many years the corresponding building material can be further used. The content of the remaining service life data 714 may be changed by repairing and/or processing the building material.

The present state data 717 represents whether the corresponding building material is stored in a warehouse or used in any of the MBs.

The special specification data 718 represents the content of a special specification if the special specification such as remodeling or special painting is applied to the corresponding building material.

The finishing method data 719 represents a specific finishing method such as discarding, burning, or dismantling.

The installation place data 709, the application data 710, the owner data 711, etc. preferably include a plurality of data if the building material is reused or reproduced a plurality of times. The data items saved in the building material DB 103 are not restricted to those shown in FIG. 7 and necessary item(s) can be suitably added or deleted.

Subsequently, the administration server 20 determines all the building materials necessary to build the MB desired to be newly built, assuming that, out of the necessary members, the building materials saved as stock in the building material DB 103 (see present data 717) are used and new products are used for those that are not saved as stock in the building material DB 103 (Step 306). Unless the user terminal 30 desires the use of reusable building materials, this flow directly proceeds to Step 306, in which all the building materials are determined on the assumption that new products are used for all the building materials. It is also possible to individually determine the building materials to be reusable or not.

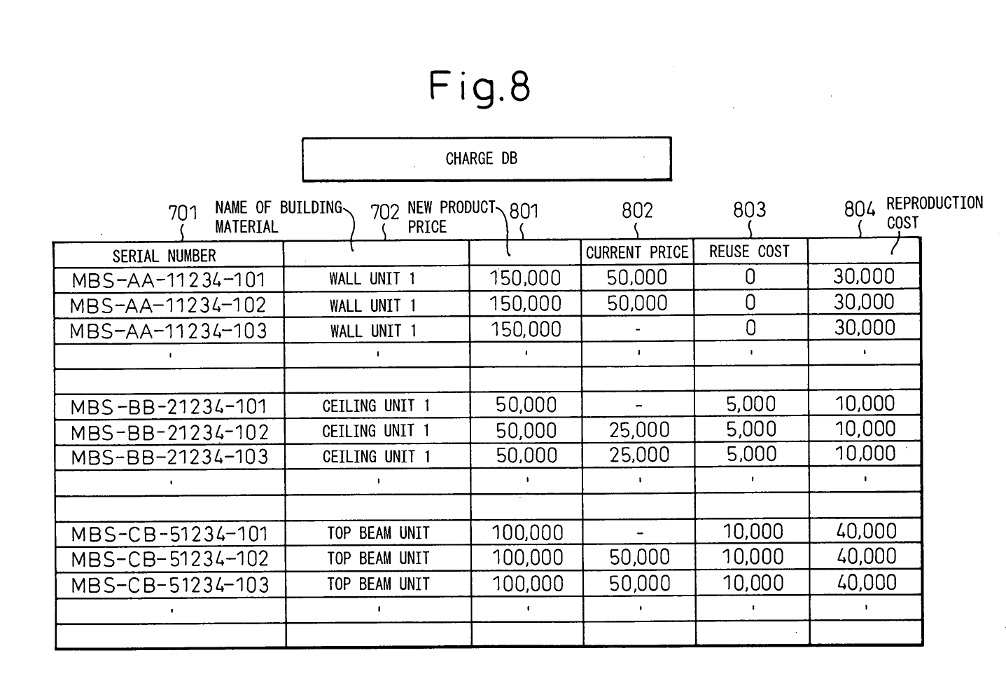

Subsequently, the administration server 20 calculates all the prices of the building materials determined in Step 306 using the charge DB 104 (Step 307). FIG. 8 shows one example of the charge DB 104. In FIG. 8, the charge DB 104 includes data items such as a serial number data 701, a building material name data 702, a new product price data 801, a current price data 802, a cost data 803 necessary in the case of reuse, and a cost data 804 necessary in the case of reproduction. The data items saved in the charge DB 104 are not restricted to those shown in FIG. 8 and necessary item(s) can be suitably added or deleted.

Subsequently, the administration server 20 automatically prepares an estimation sheet summarizing information on various costs (foundation work cost, assembling work cost, electrical work cost, waterworks cost, etc.) other than the costs for the building materials necessary in the case of actually building the MB desired to be newly built and the number of days necessary for the execution of the works, and transmits it to the user terminal 30 (Step 308). The information on the various costs and the execution of the works is preferably saved in the model DB 101 or the like beforehand in correspondence with the model types.

A user desiring the new construction of the MB can confirm the estimation sheet using a user terminal 30 of his own and, thereafter, proceed with the preparation for the actual execution of the works. At this time, in the case of using the reusable building materials, a larger cost merit can be enjoyed as compared to a case where all the building materials are new products.

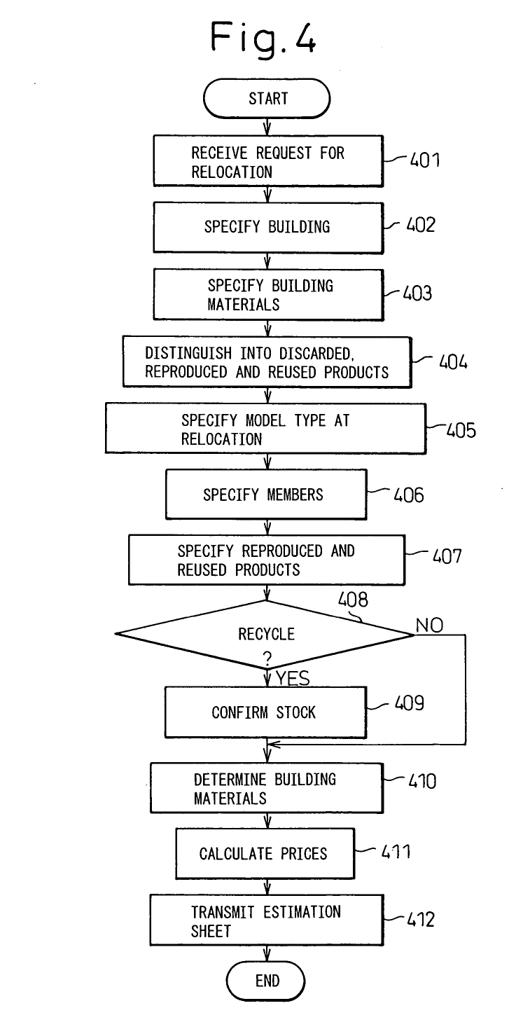

With reference to FIG. 4, a procedure of the administration method for building materials in the case of requesting an already built MB to be relocated is described. Cases where the relocation is considered include a case where a restaurant first built at certain point A is relocated to point B along a new main road as the position of the main road is changed. The procedure of FIG. 4 is mainly executed by the controller 21 in accordance with the main program saved in the storage 24.

First, the administration server 20 receives a request of relocation from the user terminal 40 of a user desiring the MB to be relocated (Step 401). It is assumed that the first request from the user terminal 40 includes information on the model type of a present MB, information on the model type of a MB at a relocation site, and information as to whether reusable building materials are used upon building the MB at the relocation site.

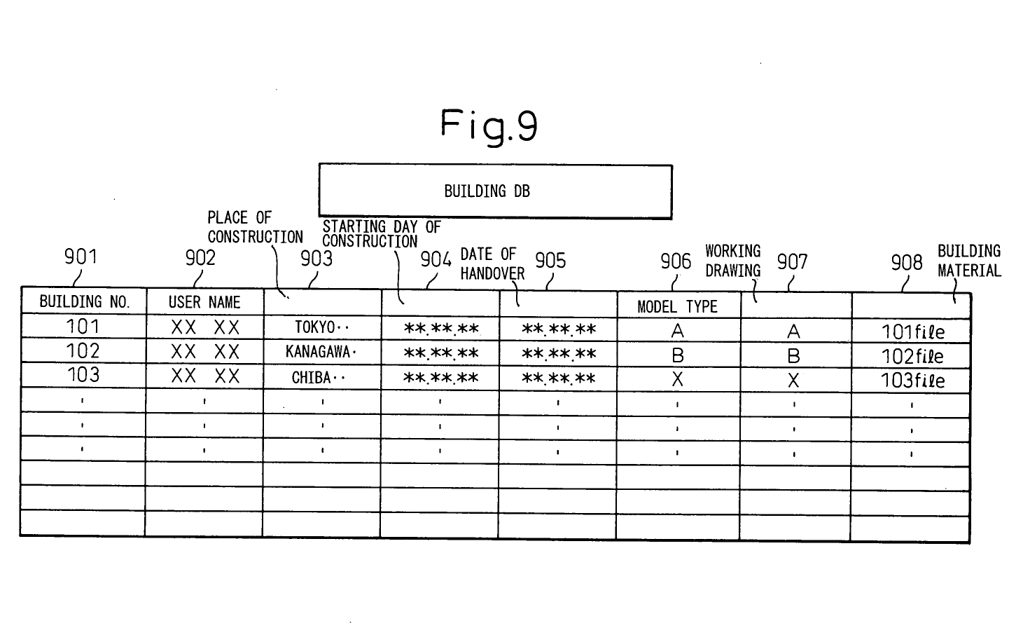

Subsequently, the administration server 20 specifies a building owned by the user of the user terminal 40 using the building DB 102 (Step 402). FIG. 9 shows one example of the building DB 102. In FIG. 9, the building DB 102 includes a building number data 901, a user name data 902, a construction starting day data 904, a building handover day data 905, a building model type data 906, a data 907 on the working drawings of the buildings, and a data 908 on all the building materials used in the buildings.

Subsequently, the administration server 20 specifies the building owned by the user of the user terminal 40 using the information from the user terminal 40, the building DB 102 or the like (Step 402). The administration server 20 further specifies all the building materials used in the building owned by the user of the user terminal 40 using the building material data 908 of the building DB 102 (Step 403).

Subsequently, the administration server 20 confirms the remaining service life data 714 and the like history information of all the building materials used in the present MB specified in Step 403 using the building material DB 103, and judges whether the respective building materials can be used as they are in the case of relocation (reused products), can be used after, for example, repairing (reproduced products) or have to be discarded (Step 404). The judgment here may be based on only the remaining service life or the other history information. In the case of using the remaining service life, the judgment criteria can be set as follows. The building material is considered as a reused product if the remaining service life is 80% or more of its useful life; is considered as a reproduced product if the remaining service life is 30% (inclusive) to 80% (exclusive) of the service life; and is discarded if the remaining service life is below 30% of the service life or is a specified unit or part determined in advance. The other history information is considered, for example, to be the past owner (see the owner data 711 of FIG. 7). Further, the building materials can be individually selected to be usable or not.

Subsequently, the administration server 20 specifies the model type of the MB at the relocation site (Step 405) and then specifies all the members necessary in the case of building the MB at the relocation site (Step 406).

Subsequently, the administration server 20 specifies the building materials usable for the MB at the relocation site out of those distinguished to be reusable as reused products or reproduced products in Step 404 (Step 407).

Subsequently, the administration server 20 judges whether or not the user terminal 40 desires to use the reusable building materials upon building the MB at the relocation site (Step 408). If the user terminal 40 desires the use of the reusable building materials, Step 409 follows.

After excluding the reused products or reproduced products specified in Step 407 from the members judged to be necessary for the MB at the relocation site in Step 406, the administration server 20 confirms whether or not there is any usable reused product or reproduced product saved as stock in the building material DB 103 (Step 409). There can be a case where the reuse of the building materials used in the present MB is desired, but the reuse of other building materials is not desired. Further, the building materials can be individually determined to be reusable or not.

Assuming that new building materials are used for the members which could not be specified in Steps 407 and 409 out of those judged to be necessary for the MB at the relocation site in Step 406, all the building materials necessary to build the MB at the relocation site selected by the user terminal 40 are determined (Step 410).

Subsequently, the administration server 20 calculates the prices of all the building materials determined in Step 410 using the charge DB 104 (Step 411). It should be noted that, out of the building materials which are used in the present MB and can be reused or reproduced, those that cannot be used in the MB at the relocation site can be sold to the company operating the administration server 20. In such a case, the cost corresponding to the current price data 802 of the charge DB 104 is subtracted from the costs for all the building materials.

Subsequently, the administration server 20 automatically prepares an estimation sheet summarizing various costs other than the costs for the building materials necessary in the case of actually building the MB at the relocation site selected by the user terminal 40 (dismantling cost for the present MB, transportation cost of the reusable building materials, foundation work cost for the MB at the relocation site, assembling work cost, electric work cost, waterworks cost, etc.) and information on the number of days necessary for the execution of the works, and transmits it to the user terminal 40 (Step 412).

The user desiring the relocation of the MB can confirm the estimation sheet using the user terminal 40 of his own and, thereafter, proceed with the preparation for the actual execution of the works. Upon receiving the cost estimation, an effort is made to use as few new building materials as possible by using the reusable building materials of the present MB and using the reusable building materials stored as stock for the members lacking in the present MB. Thus, a larger cost merit can be enjoyed as compared to a case where all the building materials are new products.

Further, by utilizing such a system, business buildings can be divided into modules and plans can be made on the premise of dismantlement and relocation. It has become possible to economically conduct dismantling and relocation by developing units having special surface structures and maximally replacing wet methods of construction by special joining methods. Further, as specific serial numbers are affixed to the respective units and the like and administered, it has become possible to securely carry out dismantlement and relocation, handle the building as a mobile property in terms of the tax law, and use a technique in accordance with the Building Standards Act.

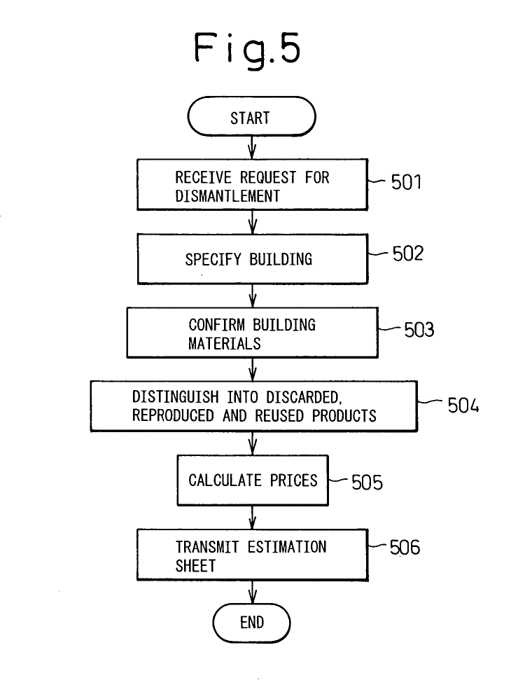

With reference to FIG. 5, a procedure of the administration method for building materials in the case of requesting an already built MB to be dismantled. In the administration server 20, the procedure of FIG. 5 is mainly executed by the controller 21 in accordance with the main program saved in the storage 24.

First, the administration server 20 receives a request of dismantling, for example, from the user terminal 50 desiring the dismantling of a MB (Step 501). It is assumed that the first request from the user terminal 50 includes information on the model type of a present MB.

Subsequently, the administration server 20 specifies the present MB owned by a user of the user terminal 50 using the building DB 102 (Step 502).

Subsequently, the administration server 20 specifies all the building materials used in the present MB owned by the user of the user terminal 50 using the building material data 908 of the building DB 102 (Step 503).

Subsequently, the administration server 20 confirms the remaining lives of all the building materials specified in Step 503 using the building material DB 103 and judges whether each building material can be used as it is (reused product) or can be used after repair (reproduced product) or has to be discarded (Step 504).

Subsequently, the administration server 20 calculates current prices of all the reusable or reproducible building materials using the charge DB 104 in accordance with the judgment result of Step 504 (Step 505).

Subsequently, the administration server 20 calculates various costs necessary in the case of dismantling the MB of the user corresponding to the user terminal 50, and automatically prepares an estimation sheet for dismantlement using a cost obtained by a total sum of the current prices of the building materials calculated in Step S505 from the various costs and transmits it to the user terminal 50 (Step 506).

The user desiring the dismantling of the MB can confirm the estimation sheet in a user terminal 50 of his own and proceed with the subsequent preparation. As the cost obtained after selling the reusable building materials of the present MB is used in the estimation sheet, a larger cost merit can be enjoyed as compared to a case where all the building materials are simply discarded. The reproduced products and the reused products obtained through the dismantlement are listed as stock in the building material DB 103 after adding past history information (see present data 717) thereto, and are used for the new construction, relocation or the like of other user(s).

Although the specific serial numbers are affixed to all the units and various parts of the MBs in the foregoing embodiment, serial numbers may not necessarily be affixed to all the units and the like. For example, there is a little necessity to affix serial numbers to expendables such as asphalt and concrete since they cannot be reused.

Further, although the MB as a building built from a plurality of building materials is described as an example in the foregoing embodiment, the present invention is also applicable to other solid materials and structures. Here, solid materials mean objects which can be independently handled and include the aforementioned building materials. Further, the structures mean objects constructed by solid materials and include the aforementioned buildings. Air-conditioning/electrical equipments, bicycles, automotive vehicles, computers and the like can be thought as other examples of the structures. Further, parts mean those handled to construct structures in computers and correspond to the members in the foregoing example.

### EFFECTS OF THE INVENTION

The administration method and system for building materials according to the present invention enable the reuse of building materials, which have been conventionally been discarded, by building a database of reusable building materials whose past history information is administered using serial numbers and using the reusable building materials for the new construction, relocation and the like of buildings.

Further, as the administration method and system for building materials according to the present invention enable the use of building materials as reproduced products and reused products, a larger cost merit can be enjoyed as compared to a case where new products are used for all the building materials.

1. An administration method for solid materials in an administration server for administering solid materials affixed with specific serial numbers, comprising the steps of:
constructing a database storing the serial numbers and pieces of history information of solid materials in one-to-one correspondence with the serial numbers for reusable solid materials;
receiving information specifying a structure built by the solid materials from a user terminal accessible via a network;
specifying all parts necessary to build the structure; and
selecting solid materials corresponding to the parts from the database.

2. An administration method for solid materials in an administration server for administering solid materials affixed with specific serial numbers, comprising the steps of:
constructing a database storing the serial numbers and pieces of history information of solid materials in one-to-one correspondence with the serial numbers for reusable solid materials;
receiving information specifying a structure built by the solid materials from a user terminal accessible via a network;
specifying all parts necessary to build the structure;
selecting solid materials corresponding to the parts from the database; and
assuming that a new solid material is used for each part which could not be selected from the database.

3. An administration method for solid materials in an administration server for administering solid materials affixed with specific serial numbers, comprising the steps of:
constructing a database storing the serial numbers and pieces of history information of solid materials in one-to-one correspondence with the serial numbers for reusable solid materials;
receiving information specifying a structure built by the solid materials from a user terminal accessible via a network;
specifying all parts necessary to build the structure;
selecting solid materials corresponding to the parts from the database;
assuming that a new solid material is used for each part which could not be selected from the database;
calculating prices of the reusable solid materials selected from the database and the new solid materials; and
transmitting the calculation result to the user terminal.
calculating prices of the reusable solid materials selected from the database and the new solid materials; and
transmitting the calculation result to the user terminal.

4. An administration method for solid materials in an administration server for administering solid materials affixed with specific serial numbers, comprising the steps of:
constructing a database storing the serial numbers and pieces of history information of solid materials in one-to-one correspondence with the serial numbers for reusable solid materials;
receiving information specifying a structure built by the solid materials from a user terminal accessible via a network;
specifying all solid materials obtained in the case of dismantling the structure; and
sorting each of all the solid materials to be any one of a reused product, a reproduced product and a discarded product in accordance with the pieces of history information using the database.

5. An administration method for solid materials in an administration server for administering solid materials affixed with specific serial numbers, comprising the steps of:
constructing a database storing the serial numbers and pieces of history information of solid materials in one-to-one correspondence with the serial numbers for reusable solid materials;
receiving information specifying a structure built by the solid materials from a user terminal accessible via a network;
specifying all solid materials obtained in the case of dismantling the structure;
sorting each of all the solid materials to be any one of a reused product, a reproduced product and a discarded product in accordance with the pieces of history information using the database; and
calculating prices of the solid materials sorted to be the reused products and the reproduced products.

6. The administration method for solid materials according to claim 1, wherein the history information is information on the remaining service life of each solid material.

7. The administration method for solid materials according to claim 1, wherein the history information is information on an owner of each reusable solid material.

8. An administration method for building materials in an administration server for administering building materials affixed with specific serial numbers, comprising the steps of:
constructing a database storing the serial numbers and pieces of history information of building materials in one-to-one correspondence with the serial numbers for reusable building materials;
receiving information specifying a building built by the building materials from a user terminal accessible via a network;
specifying all members necessary to build the building; and
selecting building materials corresponding to the members from the database.

9. An administration method for building materials in an administration server for administering building materials affixed with specific serial numbers, comprising the steps of:
constructing a database storing the serial numbers and pieces of history information of building materials in one-to-one correspondence with the serial numbers for reusable building materials; receiving information specifying a building built by the building materials from a user terminal accessible via a network;
specifying all members necessary to build the building;
selecting building materials corresponding to the members from the database; and
assuming that a new building material is used for each member which could not be selected from the database.

10. An administration method for building materials in an administration server for administering building materials affixed with specific serial numbers, comprising the steps of:
constructing a database storing the serial numbers and pieces of history information of building materials in one-to-one correspondence with the serial numbers for reusable building materials;
receiving information specifying a building built by the building materials from a user terminal accessible via a network;
specifying all members necessary to build the building;
selecting building materials corresponding to the members from the database;
assuming that a new building material is used for each member which could not be selected from the database;
calculating prices of the reusable building materials selected from the database and the new building materials; and
transmitting the calculation result to the user terminal.

11. An administration method for building materials in an administration server for administering building materials affixed with specific serial numbers, comprising the steps of:
constructing a database storing the serial numbers and pieces of history information of building materials in one-to-one correspondence with the serial numbers for reusable building materials;
receiving information specifying a building built by the building materials from a user terminal accessible via a network; product, a reproduced product and a discarded product in accordance with the pieces of history information using the database.

12. An administration method for building materials in an administration server for administering building materials affixed with specific serial numbers, comprising the steps of:
constructing a database storing the serial numbers and pieces of history information of building materials in one-to-one correspondence with the serial numbers for reusable building materials;
receiving information specifying a building built by the building materials from a user terminal accessible via a network;
specifying all building materials obtained in the case of dismantling the building;
sorting each of all the building materials to be any one of a reused product, a reproduced product and a discarded product in accordance with the pieces of history information using the database; and
calculating prices of the building materials sorted to be the reused products and the reproduced products.

13. The administration method for building materials according to claim 8, wherein the history information is the remaining service life of each building material.

14. The administration method for building materials according to claim 8, wherein the history information is information on an owner of each reusable building material.

15. An administration method for building materials, comprising the steps of:
affixing specific serial numbers to the building materials; and
administering the building materials affixed with the specific serial numbers in accordance with the specific serial numbers and information on the remaining service lives of the building materials.

16. An administration method for building materials, comprising the steps of:
affixing specific serial numbers to the building materials;
constructing a database storing the specific serial numbers, information on the building materials affixed with the specific serial numbers, and information on the remaining lives of the building materials affixed with the specific serial numbers; and
selecting the building materials which can be used for a building from the database.

17. An administration method for building materials, comprising the steps of:
affixing specific serial numbers to the building materials;
constructing a database storing the specific serial numbers, information on the building materials affixed with the specific serial numbers, and information on the remaining lives of the building materials affixed with the specific serial numbers;
specifying all building materials necessary for a building to be newly built; and
selecting the specified building materials from the database.

18. An administration method for building materials, comprising the steps of:
constructing a database storing specific serial numbers, information on building materials affixed with the specific serial numbers, and information on the remaining lives of the building materials affixed with the specific serial numbers;
specifying the building materials affixed with the specific serial numbers and usable to build a building; and
distinguishing each specified building material into any one of a reproduced product, a reused product and a discarded product using the database.

19. The administration method for building materials according to claim 16, wherein the information on the building materials is information on the prices of the building materials.

20. The administration method for building materials according to claim 16, wherein the information on the building materials is information representing whether each building material is a reproduced product or a reused product.
